(19) United States
(12) Patent Application Publication
(10) Pub. No.: US 2018/0168347 A1
(43) Pub. Date: Jun. 21, 2018

(54) FURNITURE CONNECTING AND FIXING DEVICE

(71) Applicant: Hak Sung YU, Gyeongju-si, Gyeongsangbuk-do (KR)

(72) Inventor: Hak Sung YU, Gyeongju-si, Gyeongsangbuk-do (KR)

(21) Appl. No.: 15/738,377

(22) PCT Filed: Jul. 4, 2016
(86) PCT No.: PCT/KR2016/007181

§ 371 Date: Dec. 20, 2017

(30) Foreign Application Priority Data
Jul. 10, 2015 (KR) 10-2015-0098454

(51) Int. Cl. A47B 96/06; A47B 96/14; E04B 2/82; F16M 13/00; F16B 12/12; H02N 15/00; F16B 12/40

(52) U.S. Cl. CPC A47B 96/06; A47B 96/145; E04B 2/82; F16B 2001/0035; F16B 12/12; H02N 15/00; F16B 12/40; F16M 13/005

(57) ABSTRACT

Disclosed is a furniture connecting and fixing device which allows pieces of furniture or partitions to be connected or separated without using an additional tool and which makes pieces of furniture to be firmly connected even upon an external force. The furniture connecting and fixing device includes: a female body having a female magnetic plate fixed and embedded therein; a male magnetic plate magnetically attached to the female magnetic plate; a male body having the male magnetic plate embedded therein in a manner such that a part of the male magnetic plate is able to enter and exit from the male body; and a magnetic space which is formed inside the female body and into which a part of the male magnetic plate protruding from the male body due to a magnetic force is inserted to be magnetically attached to the female magnetic plate.

### TECHNICAL FIELD

The present invention relates to a furniture connecting and fixing device and, more particularly, to a connecting and fixing device which allows pieces of furniture or partitions to be connected or separated without using an additional tool and which makes pieces of furniture to be firmly connected even upon an external force.

### BACKGROUND

Systems furniture is a package of furniture which are firmly connected to each other. Various types of furniture may be connected, such as a combination of a desk and a bookshelf and a combination of two bookshelves, or a customer may select desired kinds of furniture and use them in combination.

For connection of the systems furniture, bolts and screws are commonly used. However, connection using a bolt or a screw may loose its strength over times and may cause a damage to furniture. In addition, connection using a bolt or a screw cannot be separated without a tool. When a bolt or a screw is fastened from the outer surface of furniture, it may downgrade the aesthetic of the furniture. To fasten a bolt or a screw from the inner surface of the furniture, technical experience and expertise are required.

Furniture connecting and fixing devices have been already proposed, and a representative example thereof is Korean Patent No. 10-1252719 (which is titled “the connection apparatus for a furniture” and hereinafter referred to as an “existing art”).

As illustrated in FIG. 1, the existing art includes a support plate 20 which includes a fitting portion 21 and a protruding portion 22 and which is divided into two parts able to be piled up into one body, wherein the fitting portion 21 is inserted into a fixation hole 41 of a furniture 40 and the protruding portion 22 is fitted into a penetration hole 51 of another furniture 50. A conical part 11 is embedded on one side of the support plate 20 and inserted into the furniture 40. A connection part is formed on the other side of the support plate 20 and inserted into the fixation hole 41 of another furniture 50 so that a head portion 13 is caught by a cam 52. The protruding portion 22 of the support plate 20 has a rotatable handle 30 having an outer circumference identical to that of the protruding portion. If the rotatable handle 30 is turned by 90 degrees with the support plate 20 being inserted into the furniture 40, it is possible to pull the support plate 20 out of the furniture 40 by rotating the support plate 20.

The existing art is characterized in forming the rotatable handle 30 integrally with the support plate 20 which is inserted into the fixation hole of the furniture. Due to this characteristic, the rotatable handle 30 is maintained to have an outer circumference as the same as that of the support plate 20, and thus, it does not bother assembling the furniture and it is easy to use. In addition, if the support plate 20 is mistakenly fastened during an assembling process or if it is necessary to separate the support plate 20 from the furniture, the rotatable handle 30 formed on the outer circumferential surface of the support plate 20 is turned at 90 degrees to thereby protrude from the support plate 20 and serve as a handle. Therefore, if the support plate 20 is rotated using the rotatable handle 30, it is possible to easily separate the support plate 20 from the furniture without applying a great force. However, the connection apparatus according to the existing art is assembled by physically hitting parts to be fitted, so an additional tool is needed to assemble the apparatus. For the same reason, it is difficult to disassemble the apparatus. In addition, if the apparatus is assembled and disassembled repeatedly, it may cause a damage to the furniture or the fitting portion 21 may widen the fixation hole 41 of the furniture to the extent that the furniture 40 cannot be no longer connected or fixed.

### DISCLOSURE

### Technical Problem

An object of the present invention is to provide a furniture connecting and fixing device which allows pieces of furniture or partitions to be connected or separated without using an additional tool, which enables repeated connection and separation without leaving damage, and which makes pieces of furniture to be firmly connected firmly even upon an external force.

### Technical Solution

To achieve this object, the present disclosure provides a furniture connecting and fixing device including: a female body having a female magnetic plate fixed and embedded therein; a male magnetic plate magnetically attached to the female magnetic plate; a male body having the male magnetic plate embedded therein in a manner such that a part of the male magnetic plate is able to enter and exit from the male body; and a magnetic space which is formed inside the female body and into which a part of the male magnetic plate protruding from the male body due to a magnetic force is inserted to be magnetically attached to the female magnetic plate.

### Advantageous Effects

According to the present disclosure, the female body is embedded in one surface of a host furniture, and a male body is embedded in one surface of another furniture which comes into contact with one surface of the host furniture. When the host furniture and another furniture comes into contact with each other, the male magnetic plate embedded in the male body moves due to its magnetic force, and therefore, a part of the male magnetic plate is inserted into the magnetic space formed inside the female body and then magnetically attached to and fixed to the female magnetic plate inside of the female body. Due to the coupling of the female body and the male body, the host furniture and another furniture are connected and fixed to each other. Thus, there is no need of using an additional tool to connect and fix different pieces of furniture or different partitions.

In addition, in this connected state, the part of the male magnetic plate is magnetically attached to the female magnetic plate inside the female body while being embedded in the magnetic space inside the female body. Thus, the connected state is never disconnected by an external shock which is applied in a direction in which the male magnetic plate is inserted into the magnetic space. The connected state can be disconnected only when a force greater than a magnetic force between the female magnetic plate and the male magnetic plate inside the female body is applied so that the part of the magnetic plate is separate from the magnetic space inside the female body. Even for the separation, it is not necessary to use an additional tool.

In addition, it is possible to connect and fix pieces of furniture by contacting a female body and a male body respectively embedded therein, and it is possible to separate the pieces of furniture by parting the pieces apart from each other. Thus, it is efficient when it comes to connecting and separating pieces of furniture.

### BRIEF DESCRIPTION OF THE DRAWINGS

FIG. 1 is a cross-sectional view of a configuration of an existing art.

FIG. 2 is an exploded perspective view of an entire configuration of a furniture connecting and fixing device according to an embodiment of the present disclosure.

FIGS. 3 to 5 are operation diagrams of a furniture connecting and fixing device according to an embodiment of the present disclosure.

FIGS. 6 and 7 are operation diagrams showing connection between pieces of furniture using a furniture connecting and fixing device according to an embodiment of the present disclosure.

FIG. 8 is a front perspective view showing connection between partitions using a furniture connecting and fixing device according to an embodiment of the present disclosure.

FIG. 9 is a cross-sectional view of a male magnetic plate of a furniture connecting and fixing device according to another embodiment of the present disclosure.

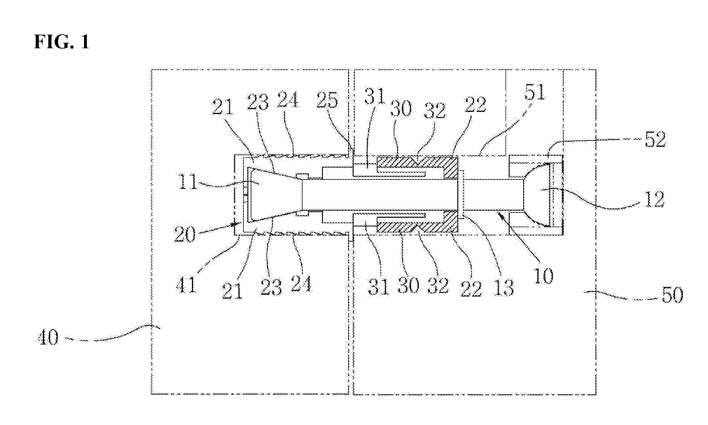

### BEST MODE

A furniture connecting and fixing device according to the present disclosure includes: a female body having a female magnetic plate fixed and embedded therein; a male magnetic plate magnetically attached to the female magnetic plate; a male body having the male magnetic plate embedded therein in a manner such that a part of the male magnetic plate is able to enter and exit from the male body; and a magnetic space which is formed inside the female body and into which a part of the male magnetic plate protruding from the male body due to a magnetic force is inserted to be magnetically attached to the female magnetic plate.

Detailed embodiments of the present disclosure are described as below so that a person skilled in the art can implement the present disclosure with reference to the accompanying drawings.

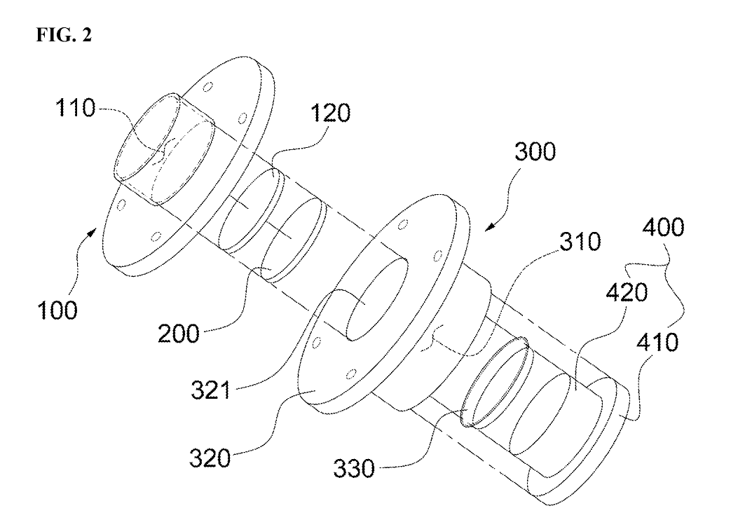

The entire configuration of a furniture connecting and fixing device according to an embodiment of the present disclosure is shown in FIG. 2.

As shown in the drawing, the furniture connecting and fixing device according to an embodiment of the present disclosure includes: a female body 100 having a female magnetic plate 200 fixed and embedded therein; a male magnetic plate 400 magnetically attached to the female magnetic plate 200; a male body 300 having the male magnetic plate 400 embedded therein in a manner such that that a part of the male magnetic plate 400 is able to enter and exit from the male body 300; and a magnetic space 110 which is formed inside the female body 100 and into which a part of the male magnetic plate 400 protruding from the male body 300 due to a magnetic force is inserted to be magnetically attached to the female magnetic plate 200.

More specifically, as illustrated in FIGS. 2 to 5, the male body 300 is embedded in a piece of furniture or a partition to be connected or in an additional part such as a leg to be connected to the furniture, and the male body 300 has the male magnetic plate 400 embedded therein. In addition, an operation space 310 in which the male magnetic plate 400 is movable is formed inside the male body 300. A separation prevention part 320 which prevents separation of the male magnetic plate 400 is formed at one end of the operation space 310. An exit hole 321 through which a part of the male magnetic plate 400 is able to enter and exit may be formed in the separation prevention part 320. An elastic body 330 is provided between the separation prevention part 320 and the male magnetic plate 300 so that the male magnetic plate 400 returns to its original place without protruding.

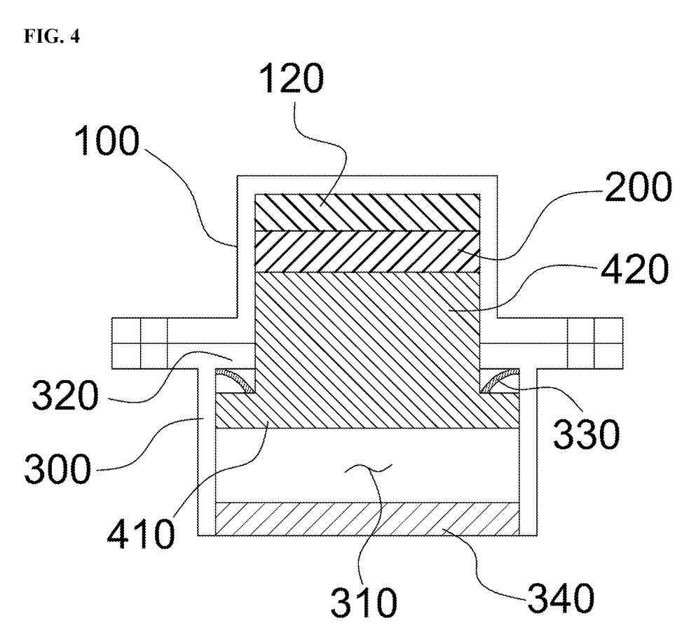

The elastic body 330 may be in the form of a spring. In addition, the elastic body 330 may be formed of a synthetic resin band, a rubber band, and the like which is elastic enough to prevent noise caused by operation of the male magnetic plate 400. Furthermore, as shown in FIGS. 2 and 4, the elastic body 330 may be in the form of an elastic funnel which is in close contact with the inner surface of the separation prevention part 320 not to intervene the male magnetic plate 400.

As illustrated in FIGS. 2 to 4, the male magnetic plate 400 embedded in the male body 300 includes: a base part 410 which has a shape similar to the inside of the male body 300 and a size close to that of the inside of the male body 300 so that the base 410 is movable back and forth in one direction inside the make body 300 without being distorted; and a magnetic part 420 which protrudes from the base part 410 and which enters the exit hole 321 of the separation prevention part 320 due to movement of the base part 410 to thereby be inserted into the magnetic space 110 of the female body 100.

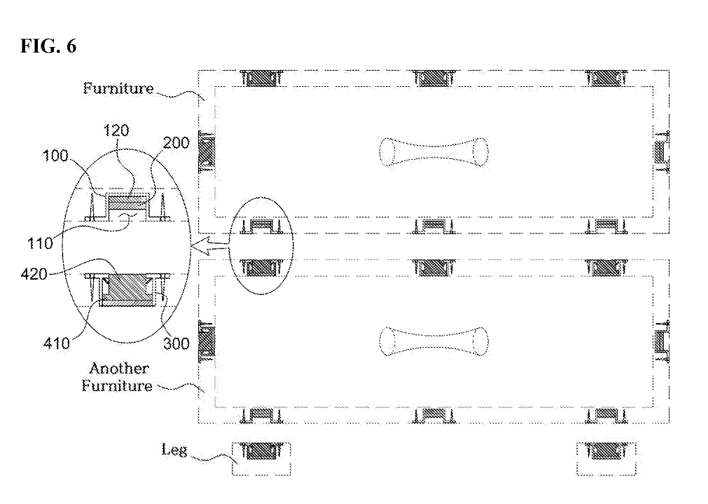

In addition, a female magnetic plate 200 with a great magnetic force is embedded in the female body 100. As shown in FIGS. 6 to 8, the female body 100 also includes the magnetic space 110 which is formed in a location which comes into close contact with the male body 300, into which the magnetic part 420 of the male magnetic plate 400 able to move due to a magnetic force is inserted, which allows the inserted magnetic part 420 of the male magnetic plate 400 is magnetically attached to the female magnetic plate 200, and which has a shape and a size similar to those of the exterior of the magnetic part 420 so that the magnetic part 420 of the male magnetic plate 400 magnetically attached to the female magnetic plate 200 is allowed to move only in a direction in which the magnetic part is inserted.

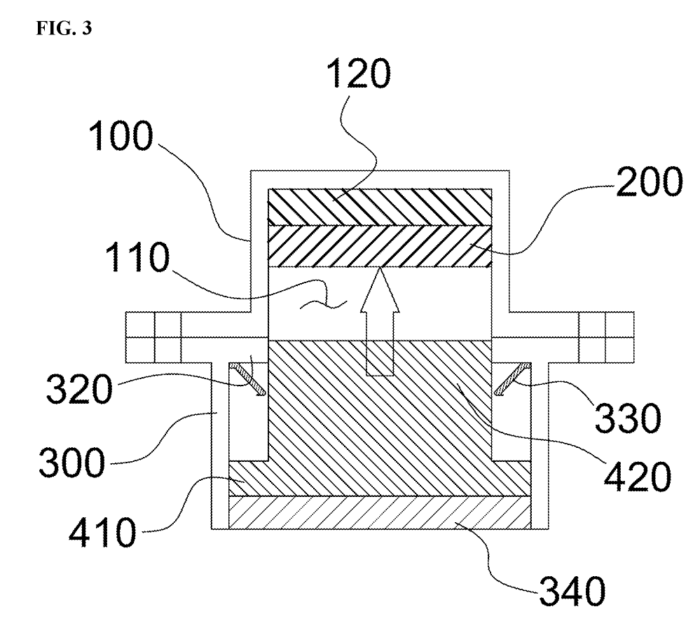

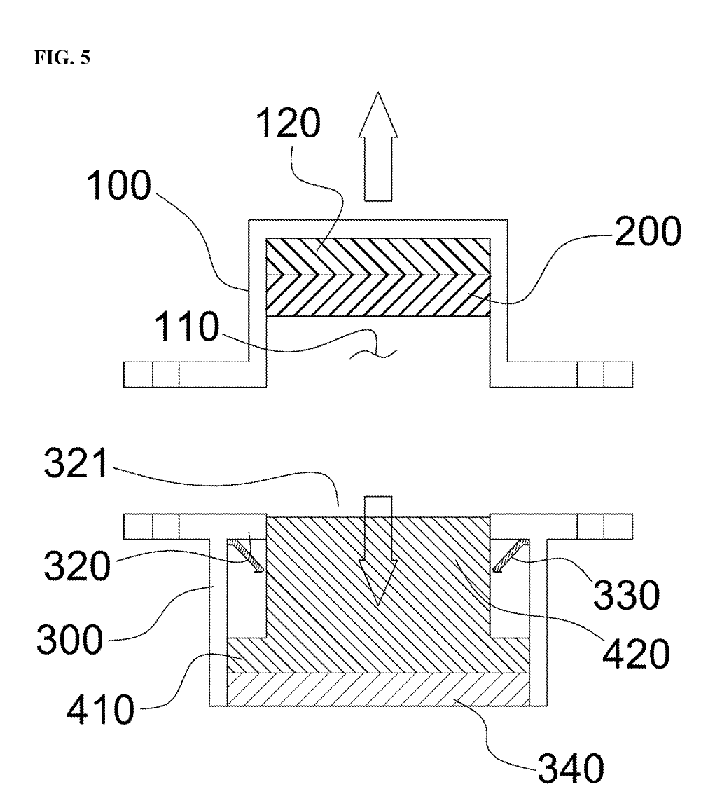

The furniture connecting and fixing device according to the present disclosure may be implemented such that one surface of another furniture having the female body 100 embedded therein is connected to one surface of a host furniture having the male body 300 embedded therein, as shown in FIGS. 3 to 5. Then, the movable magnetic plate 400 moves due to a magnetic force of its own, as shown in FIG. 3. Then, the magnetic part 420 of the male magnetic plate 400 is inserted into the magnetic space 110 of the female body 100, as shown in FIG. 4. Accordingly, the magnetic part 420 of the male magnetic plate 400 is magnetically attached to the female magnetic plate 200 fixed inside the female body 100, and a side surface of the magnetic part 420 is supported by a wall surface of the magnetic space 110, and therefore, the host furniture and another furniture are allowed to move only in a direction in which the magnetic part 420 is inserted (an upward direction in FIGS. 3 to 5) and it is possible to retain a firm connected state. To separate the host furniture from another furniture, as shown in FIG. 5, a force greater than the magnetic force between the magnetic part 420 of the male magnetic plate 400 and the female magnetic plate 200 is applied in the direction in which the magnetic part 420 is inserted (in the upward direction in FIGS. 3 to 5) to move the furniture. Then, the magnetic part 420 and the female magnetic plate 200 are separated, and the male magnetic plate 400 is moved by the elastic body 330 to its original place (in a downward direction in FIGS. 3 to 5), resulting in separation of the host furniture and another furniture.

That is, simply by contacting the host furniture and another furniture or parting them apart from each other, it is possible to repeatedly connect and separate the host furniture and another furniture in a manner in which the male magnetic plate 400 of the male body 300 moves to be inserted into the magnetic space 110 inside the female body 100 and accordingly the magnetic part 420 of the male magnetic plate 400 is magnetically attached to the female magnetic plate 200 or separate from the female magnetic plate 200. Accordingly, this makes it easy to connect and separate a furniture and eliminate a need to use an additional tool.

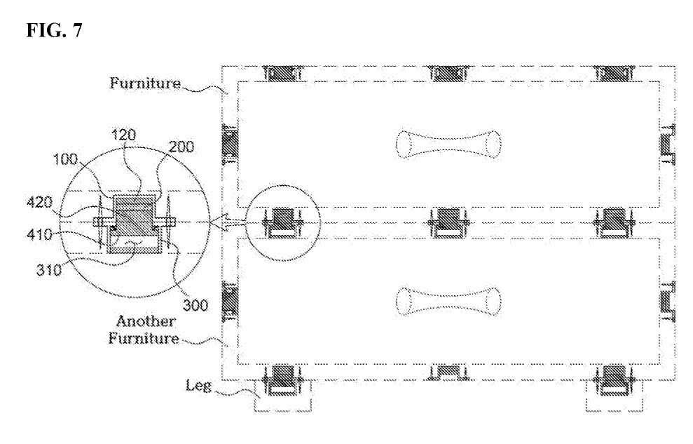

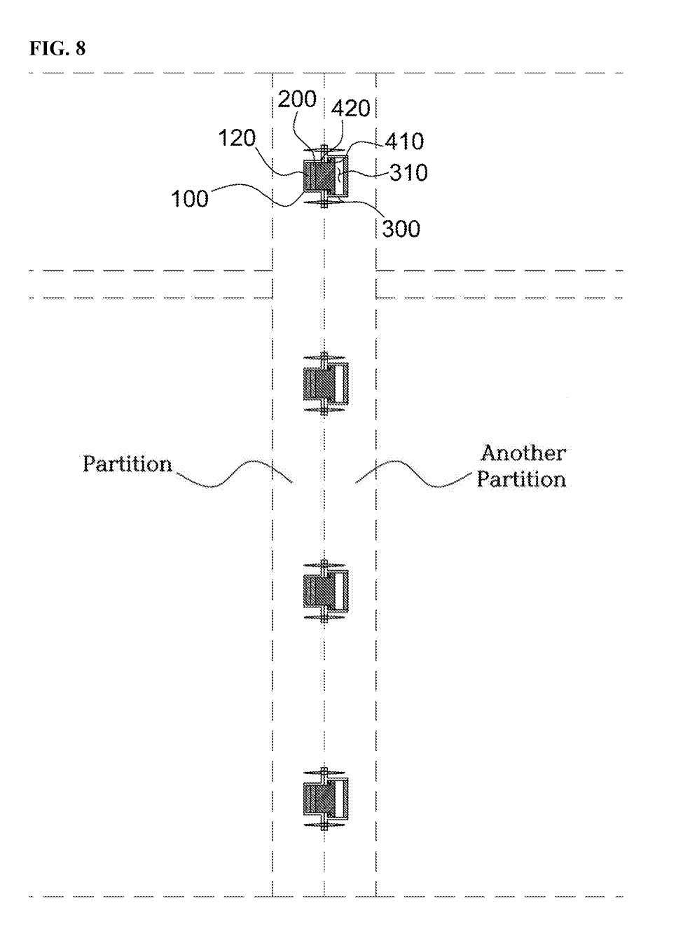

The furniture connecting and fixing device according to an embodiment of the present disclosure may be used to connect and separate pieces of furniture and an additional part such as a leg, as shown in FIGS. 6 and 7, and even to connect and separate a partition, as shown in FIG. 8.

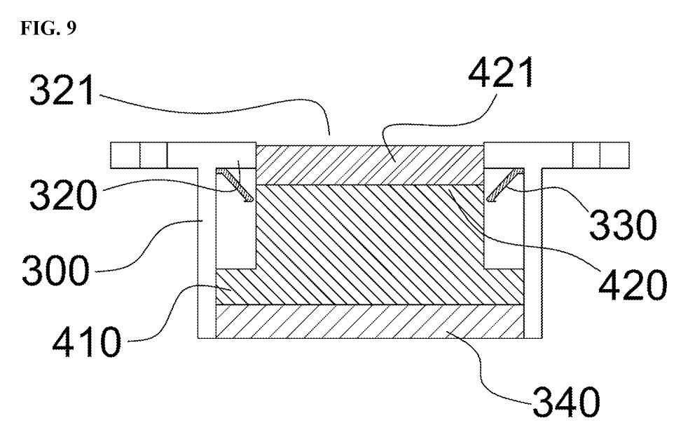

In addition, the male magnetic plate 400 and the female magnetic plate 200 in the furniture connecting and fixing device according to the present disclosure may be natural magnets with different polarities. To enhance cohesion strength, the female magnetic plate 200 may be formed of a magnet and the male magnetic plate 400 may be formed of a ferro magnetic material (iron or the like). The male magnetic plate 400 may be disposed on the top surface of furniture, as shown in FIGS. 6 and 7, and thus, the male magnetic plate 400 is able to move and be magnetically attached only when the weight of the male magnetic plate 400 is less than its magnetic force. Therefore, it is desirable that the male magnetic plate 400 is formed of an engineering plastic having an iron layer 421 at one end, as shown in FIG. 9, in order to minimize the weight of the male magnetic plate 400, enhance strength of the male magnetic plate 400, and allow the male magnetic plate 400 to be magnetically attached to the female magnetic plate 200 which is formed of a magnetic material.

In addition, the female magnetic plate 200 may be formed of a magnet with a great magnetic force and the magnetic force of the female magnetic plate 200 may harm stuff kept inside the furniture. Thus, it is desirable that the female magnetic plate 200 is configured to affect only connection between pieces of furniture. Accordingly, the female body 100 having the female magnetic plate 200 embedded therein may be formed of a material that shields a magnetic force, so there may be a magnetic force shield part 120 which allows the magnetic force of the female magnetic plate 200 to flow only in one direction.

In addition, it is desirable that the magnetic part 420 of the male magnetic plate 400 embedded in the male body 300 is adjusted so that an end surface of the magnetic part 420 and a surface of the exit hole 321 of the separation prevention part 320 are positioned at the same level at ordinary times (in a separate state). It is because the magnetic part 420 is possibly caught if the end surface of the magnetic part 420 protrudes from the surface of the exit hole 321 of the separation prevention part 320 or because a foreign substance comes in to disturb magmatic attachment if the end surface of the magnetic part 420 caves in the surface of the exit hole 321 of the separation prevention part 320. To address this problem, there may be a space adjustment part 340 which supports the base part 410 of the male magnetic plate 400 so that the end surface of the magnetic part 420 of the male magnetic plate 400 and the surface of the exit hole 321 of the separation prevention part 320 are positioned at the same level.

Although the exemplary embodiments of the present disclosure have been disclosed with reference to the accompanying drawings, the present disclosure is not limited thereto. Therefore, it is apparent that the present invention may be modified in size, shape, and structure by those skilled in the art without departing from the scope of the present invention and those modifications and copies are included in the scope of the present invention.

What is claimed is:

1. A furniture connecting and fixing device comprising:
a female body having a female magnetic plate fixed and embedded therein;
a male magnetic plate magnetically attached to the female magnetic plate;
a male body having the male magnetic plate embedded therein in a manner such that a part of the male magnetic plate is able to enter and exit from the male body; and
a magnetic space which is formed inside the female body and into which a part of the male magnetic plate protruding from the male body due to a magnetic force is inserted to be magnetically attached to the female magnetic plate.

2. The furniture connecting and fixing device of claim 1, wherein the male magnetic plate comprises: a base part which is embedded in the male body and movable inside the male body; and a magnetic part which protrudes from the base part and which is able to be inserted into the magnetic space formed inside the female body.

3. The furniture connecting and fixing device of claim 1, wherein the male magnetic plate is embedded in the male body, an operation space where the male magnetic plate is movable is formed in the male body, a separation prevention part which prevents separation of the male magnetic plate is formed at one end of the operation space, and an elastic body for allowing the male magnetic plate to return to an original place thereof is provided between the separation prevention part and the male magnetic plate.

4. The furniture connecting and fixing device of claim 1, wherein the male magnetic plate is formed of an engineering plastic having an iron layer in order to minimize a weight of the male magnetic plate and be magnetically attached to the female magnetic plate which is formed of a magnetic material.

5. The furniture connecting and fixing device of claim 1, wherein the female body comprises a magnetic force shield part which allows a magnetic force of the female magnetic plate to flow only in one direction.
